(19) United States
(12) Patent Application Publication
(10) Pub. No.: US 2013/0200817 A1
(43) Pub. Date: Aug. 8, 2013

(54) Method for Minimizing Stroboscopic Effects in PWM Driven Lighting

(71) Applicants: Richard Landry Gray, Saratoga, CA (US); Samuel Chiyin Leung, Saratoga, CA (US)

(72) Inventors: Richard Landry Gray, Saratoga, CA (US); Samuel Chiyin Leung, Saratoga, CA (US)

(21) Appl. No.: 13/760,050

(22) Filed: Feb. 6, 2013

Related U.S. Application Data
(60) Provisional application No. 61/595,327, filed on Feb. 6, 2012.

(51) Int. Cl. H05B 37/02

(52) U.S. Cl. CPC H05B 37/02
USPC 315/250

(57) ABSTRACT

An approach is provided for a method that minimizes stroboscopic effects in PWM driven lighting, which comprises acts of generating at least two enabling signals that drive at least one corresponding lamp, adjusting widths of pulses of each enabling signal corresponding to specific timestamps by a predetermined rule, and forming an overall brightness output in response to the superposition of the enabling signals. Each enabling signal is synchronized to an input power of the lamp. The method of the present invention makes light from lamps using multiple phases that significantly minimize stroboscopic effect.

Embodiments relate to pulse-width modulation (PWM) driving methods, especially to a method that minimizes stroboscopic effects in PWM driven lighting.

### BACKGROUND

Pulse-width modulation (PWM) is a commonly used technique for controlling power to electrical devices, which can be used to turn a dimmable lamp on or off at the most optimal operating points for a maximally efficient design. In a properly designed lamp, that uses PWM dimming, when the output has been adjusted to 50% brightness then the input power is also 50% of the maximum value. When the PWM dimming frequency is higher than 200 Hz, there are no health risks to humans' eyes. The higher the PWM dimming frequency the better the visual comfort.

However, there is one area where PWM lamp dimming may not be ideal, for instance, when illuminating spinning machinery or other types of machinery that have some type of periodic motion. In that case the stroboscopic effect of illuminating the periodic motion of the equipment with a periodic light source may cause optical effects that are not ideal.

Accordingly, the stroboscopic effect is a visual phenomenon caused by aliasing that occurs when continuous motion is represented by a series of short or instantaneous samples. It occurs when the view of a moving object is represented by a series of short samples as distinct from a continuous view, and the moving object is in rotational or other cyclic motion at a rate close to the sampling rate or at some multiple of the sampling rate. The stroboscopic effect may cause terrible illusions and may adversely affect epilepsy sufferers.

Therefore, there is a need to minimize the stroboscopic effect when the lamp is dimmed using PWM technique.

### SOME EXEMPLARY EMBODIMENTS

These and other needs are addressed by the exemplary embodiments, in which one approach provides for minimizing stroboscopic effects in PWM driven lighting.

According to one embodiment, a method for minimizing stroboscopic effects in PWM driven lighting comprises acts of generating at least two enabling signals that drive at least one corresponding lamp, adjusting widths of pulses of each enabling signal corresponding to specific timestamps by a predetermined rule, and forming an overall brightness output in response to the superposition of the enabling signals. Each enabling signal is synchronized to an input power of the lamp.

The method of the present invention makes a composite illumination from lamps driven with multiple phases that significantly minimize the stroboscopic effect.

Still other aspects, features, and advantages of the exemplary embodiments are readily apparent from the following detailed description, simply by illustrating a number of particular embodiments and implementations, including the best mode contemplated for carrying out the exemplary embodiments. The exemplary embodiments are also capable of other and different embodiments, and their several details can be modified in various obvious respects, all without departing from the spirit and scope of the exemplary embodiments. Accordingly, the drawings and description are to be regarded as illustrative, and not as restrictive.

### BRIEF DESCRIPTION OF THE DRAWINGS

The exemplary embodiments are illustrated by way of examples, and not by way of limitation, in the figures of the accompanying drawings in which like reference numerals refer to similar elements and in which:

FIG. 1 is a flow chart for a method for minimizing stroboscopic effects in PWM driven lighting in accordance with an embodiment of the present invention;

FIG. 2 is a exemplary waveforms indicating relations among enabling signals and overall brightness output in accordance with an embodiment of the present invention;

FIG. 3 is an exemplary waveforms indicating relations among enabling signals and overall brightness output in accordance with another embodiment of the present invention;

FIG. 4 is an exemplary waveforms indicating relations among enabling signals and overall brightness output in accordance with another embodiment of the present invention;

FIG. 5 is an exemplary waveforms indicating relations among enabling signals and overall brightness output in accordance with another embodiment of the present invention;

FIG. 6 is an exemplary waveforms indicating relations among enabling signals and overall brightness output in accordance with another embodiment of the present invention; and

FIG. 7 is exemplary waveforms indicating relations between an enabling signal and overall brightness output in accordance with another embodiment of the present invention.

### DESCRIPTION OF THE PREFERRED EMBODIMENT

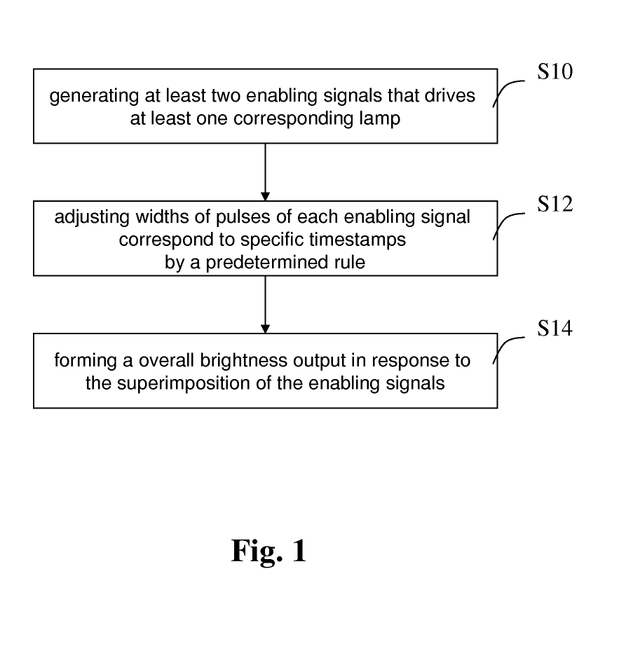

With reference to FIG. 1, FIG. 1 is a flow chart for a method for minimizing stroboscopic effects in PWM driven lighting. In an embodiment, the method comprises acts of S10 generating at least two enabling signals that drives at least one corresponding lamp, S12 adjusting widths of pulses of each enabling signal correspond to specific timestamps by a predetermined rule, and S14 forming an overall brightness output in response to the superposition of the enabling signals. Each enabling signal is synchronized to an input power of the lamp.

In an embodiment, the enabling signals are synchronized to a line voltage. In order for large scale PWM dimming to be possible, the dimming frequency of each lamp in a room should be synchronized to each other, if that were not the case then the differences in PWM dimming frequency between the lamps would cause “beat frequency problems”. For example, if one lamp's PWM dimming frequency is 200 Hz, and an adjacent lamp's PWM dimming frequency is 201 Hz, then the difference frequency of 1 Hz would be perceptible to a person in the room illuminated by those lamps (frequencies above 120 Hz are generally thought to be consciously imperceptible to human beings).

The more important reason behind the synchronization aspect of the present invention is that all enabling signals must be synchronized for eliminating stroboscopic effects by interspersing the “on” times of one lamp with the “off” times of another lamp (step S12).

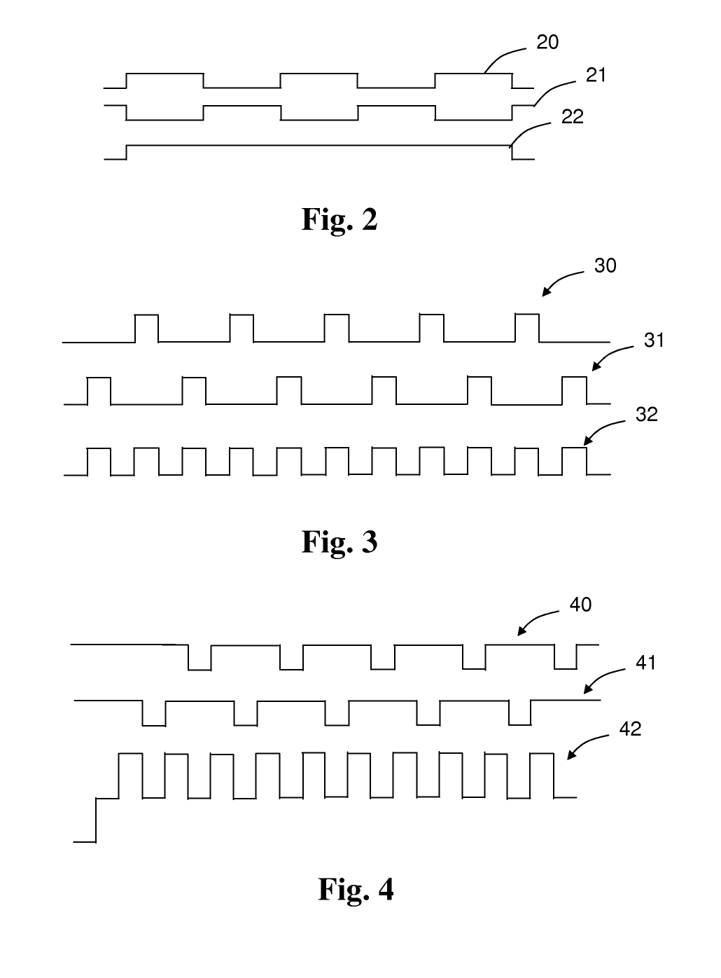

With reference to FIG. 2, FIG. 2 shows exemplary waveforms indicating relations among enabling signals and overall brightness output in accordance with an embodiment of the present invention. In this embodiment, as shown in FIG. 2, the enabling signals have a first enabling signal 20 and a second enabling signal 21 which drives the two separate lamps respectively.

As mentioned in previous paragraph, the step S12 indicates acts of adjusting widths of pulses of each enabling signal that correspond to specific timestamps by the predetermined rule. In this embodiment of FIG. 2, the “off” times of the lamp driven by the first enabling signal 20 coincide with the “on” time of the lamp driven by the second enabling signal 21. A person skilled in art will realize that this embodiment works perfectly for 50% duty cycle, and the overall brightness output 22 is constant. Accordingly, the predetermined rule of this embodiment is to adjust widths of pulses of the first enabling signal 20 and the second enabling signal 21 for 50% duty cycle and each pulse of the second enabling signal 21 is adjacent to the pulse of the first enabling signal 20.

With reference to FIG. 3, FIG. 3 shows exemplary waveforms indicating relations among enabling signals and overall brightness output in accordance with another embodiment of the present invention. In this embodiment, as shown in FIG. 3, the duty cycles of the first enabling signal 30 and the second enabling signal 31 are the same and below 50%. For duty cycles lower than 50% there will be times when both lamps are off. However there is still an advantage in that the effective PWM dimming frequency has been raised by 2 times over the PWM dimming frequency of the embodiment shown in FIG. 2, and the overall brightness output 32 is constant.

With reference to FIG. 4, FIG. 4 shows exemplary waveforms indicating relations among enabling signals and overall brightness output in accordance with another embodiment of the present invention. This embodiment of FIG. 4 shows the duty cycles of the first enabling signal 40 and the second enabling signal 41 are above 50%, and valleys of every two pulses of the enabling signals 40, 41 are sequentially aligned. For duty cycles above 50%, as shown in FIG. 4, there are portions of each period where both lamps are on at the same time creating a momentary doubling of light energy (see the height of the overall brightness output 42). In the same way as described previously there is still improvement because the effective dimming frequency is still 2 times more, and the composite illumination never turns off all the way.

According to the above mentioned embodiments, the method of the present invention makes a light from lamps made up of multiple phases that significantly minimize the stroboscopic effect.

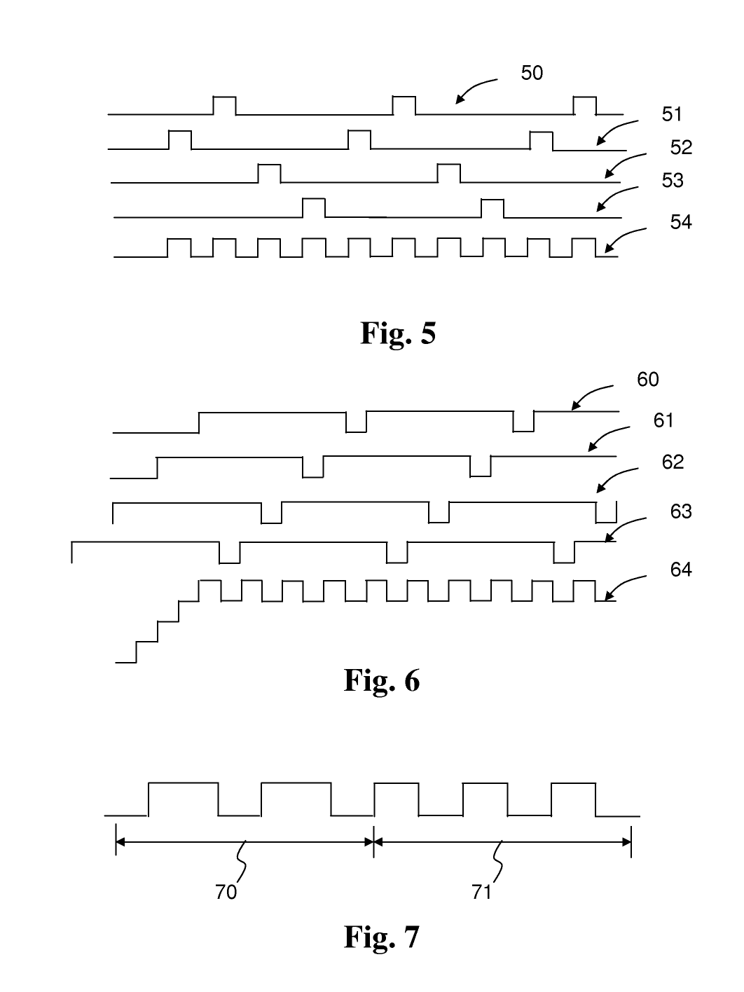

With reference to FIGS. 5 and 6, FIGS. 5 and 6 show exemplary waveforms indicating relations among enabling signals and overall brightness output in accordance with other embodiments of the present invention, when more lamps are added. The embodiments of FIGS. 5 and 6 show a four phase application, and it can be extended to N phases. The number of phases is based on the number of the lamps. In the embodiment of FIG. 5, the enabling signal has a first enabling signal 50, a second enabling signal 51, a third enabling signal 52 and a fourth enabling signal 53, which drive four lamps respectively. The predetermined rule of this embodiment is to adjust the duty cycles of the enabling signals 50˜53 below 25%, and pulses of the enabling signals 50˜53 are sequentially generated.

The embodiment of the FIG. 6 is similar to the embodiment of the FIG. 5, which also comprises four enabling signals 60˜63 to drive four different lamps. The difference between those two embodiments is that FIG. 5 is adapted for a lower brightness application, and FIG. 6 is adapted for a high brightness application. The predetermined rule of the embodiment of FIG. 6 adjusts the duty cycles of the enabling signals 60˜63 above 75%, valleys of every two pulses of the enabling signals 60˜63 are sequentially aligned. However, a person skilled in art will realize that the duty cycle described in the embodiments of FIGS. 5 and 6 can be adjusted at least below 49% and above 51% respectively.

Moreover, multiple lamps can be all put into one lamp fixture so that the fixture has the look and practicality of a standard lighting device yet inside are numerous separate lighting devices. One excellent application would be in office lighting where four different lamps are put into the same “bay” in the ceiling. Often the ceiling of the office is a modular drop ceiling using hanging ceiling tiles and modular light fixtures. Each lamp in the modular light fixture would correspond to one of the phases (i.e. enabling signal), and the modular light fixture would generate overall brightness outputs 54, 64 shown in FIGS. 5 and 6.

To further improve the situation the frequency and phase of each lamp in an illuminated area (or within a single lamp with separate lighting elements inside the lamp that are driven with different “on” and “off” enabling signals), the predetermined rule is to adjust pulses of the enabling signal in a random fashion so that the exact phase and frequency of each lighting element is not exact. In this way any stroboscopic effect with periodic moving machinery will get “washed” away. It would be most advantageous if the frequency/phase dithering did not vary in its own periodic fashion but rather in a random, noisy fashion. If the dithering were periodic then any stroboscopic effect may appear to move in a periodic fashion as well

With reference to FIG. 7, FIG. 7 indicates relations between the enabling signal and overall brightness output in accordance with another embodiment of the present invention. This embodiment changes the frequency and/or the pattern of on/off pulses of the enabling signal on a regular basis but keeps the overall duty cycle constant. Since the enabling signal is synchronized to the input power (e.g. 60 Hz line voltage) the predetermined rule is able to precisely divide the enabling signal into at least two segments with different pulse patterns. In this embodiment, the predetermined rule consists of a 240 Hz on/off pulse patterns (i.e. 2 pulses in half cycle) for the first half line cycle 70, and 360 Hz on/off pulse patterns (i.e. 3 pulses in half cycle) for the second half line cycle 71. This variation occurs on a roughly 8 mS period, the overall brightness output is constant. Since the frequency of the pulses of the enabling signal is always higher than 200 Hz and is constantly changing, it is not perceptible to a person and most stroboscopic effects will be eliminated.

While the exemplary embodiments have been described in connection with a number of embodiments and implementations, the exemplary embodiments are not so limited but cover various obvious modifications and equivalent arrangements, which fall within the purview of the appended claims. Although features of the exemplary embodiments are expressed in certain combinations among the claims, it is contemplated that these features can be arranged in any combination and order.

What is claimed is:

1. A method that minimizes stroboscopic effects in PWM driven lighting, which drives at least one lamp in a multiple-phases mode, and the method comprising:
generating at least two enabling signals that drives at least one corresponding lamp, wherein each enabling signal is synchronized to an input power of the lamp;
adjusting widths of pulses of each enabling signal correspond to specific timestamps by a predetermined rule; and
forming a overall brightness output in response to the superposition of the enabling signals.

2. The method as claimed in claim 1, wherein the input power is a line voltage, and frequency of the enabling signal is higher than 120 Hz.

3. The method as claimed in claim 2, wherein the enabling signal has a first enabling signal and a second enabling signal that drives two separate lamps respectively.

4. The method as claimed in claim 3, wherein the predetermined rule is configured for adjusting widths of pulses of the first enabling signal and the second enabling for 50% duty cycle, and each pulse of the second enabling signal is adjacent to the pulse of the first enabling signal.

5. The method as claimed in claim 3, wherein the predetermined rule is configured for adjusting widths of pulses of the first enabling signal and the second enabling above 50%, and valleys of every two pulses of the first enabling signal and the second enabling signal are sequentially aligned

6. The method as claimed in claim 2, wherein the enabling signal has a first enabling signal, a second enabling signal, a third enabling signal and a fourth enabling signal that drives four separate lamps respectively.

7. The method as claimed in claim 6, wherein the predetermined rule configured for adjusting the duty cycles of the first to fourth enabling signals, and pulses of the enabling signals are sequentially generated.

8. The method as claimed in claim 6, wherein the predetermined rule configured for adjusting the duty cycles of the first to fourth enabling signals, and valleys of every two pulses of the enabling signals are sequentially aligned.

9. The method as claimed in claim 2, wherein the predetermined rule is configured for changing the frequency of the pulses of the enabling signal while keeping the overall duty cycle constant.

10. The method claimed in claim 9 wherein the frequency changes randomly within a predefined range of frequency.

11. A method that minimizes stroboscopic effects in PWM driven lighting, which drives a lamp in a multiple-phases mode, and the method comprising:
generating at least two enabling signals that drives the lamp, wherein each enabling signal is synchronized to a line voltage;
adjusting widths of pulses of each enabling signal correspond to specific timestamps by a predetermined rule, wherein each successive half line cycle of the line voltage uses a frequency different from the enabling signal of the previous half line cycle of the line voltage; and
forming a overall brightness output in response to the superposition of the enabling signals.

12. The method as claimed in claim 11, the predetermined rule is configured so that there are 2 pulses with a 240 Hz frequency for the previous half line cycle, and 3 pulses with a 360 Hz frequency for the successive half line cycle.

13. The method as claimed in claim 11, wherein each adjacent half line cycle alternates between 2 different frequencies.
